(19) United States
(12) Patent Application Publication
(10) Pub. No.: US 2014/0033215 A1
(43) Pub. Date: Jan. 30, 2014

(54) SCHEDULING METHOD AND SCHEDULING SYSTEM

(71) Applicant: FUJITSU LIMITED, Kawasaki-shi (JP)

(72) Inventors: Toshiya Otomo, Kawasaki (JP); Koichiro Yamashita, Hachioji (JP); Naoki Odate, Akiruno (JP); Takahisa Suzuki, Kawasaki (JP); Hiromasa Yamauchi, Kawasaki (JP)

(73) Assignee: FUJITSU LIMITED, Kawasaki-shi (JP)

(21) Appl. No.: 14/037,776

(22) Filed: Sep. 26, 2013

Related U.S. Application Data
(63) Continuation of application No. PCT/JP2011/057907, filed on Mar. 29, 2011.

(51) Int. Cl. G06F 9/46

(52) U.S. Cl. CPC G06F 9/46
USPC 718/102

(57) ABSTRACT

A scheduling method that is executed by a first device includes acquiring in response to a process request received by the first device, any one among a device count of peripheral devices near the first device and a device count of the peripheral devices near the first device, including the first device; and determining, by a CPU of the first device, a scheduling method for scheduling a process corresponding to the process request, based on the device count.

### CROSS REFERENCE TO RELATED APPLICATIONS

This application is a continuation application of International Application PCT/JP2011/057907, filed on Mar. 29, 2011 and designating the U.S., the entire contents of which are incorporated herein by reference.

### FIELD

The embodiment discussed herein is related to a scheduling method and scheduling system that determine process assignment destinations.

### BACKGROUND

According to a known conventional technique for load distributed, a process under execution by a given terminal is distributed to and executed by multiple terminals. For example, according to a known load control technique, when the size of a load becomes greater than or equal to a reference value in load distributed processing by a server, a connection request from a terminal is directed to a different server (see, e.g., Japanese Laid-Open Patent Publication No. 2009-237935).

Depending on the algorithm, however, the volume of calculations for solving a problem of scheduling for assigning a process to an optimal computing node increases exponentially as the number of processes and nodes increases. For example, when the number of processes is m and the number of nodes is N, time complexity resulting from calculation by the critical path/most immediate successors first (CP/MISF) method is O(m2+Nm). This indicates that the volume of calculations grows enormously as the number of nodes increases, thus creating a calculation load far exceeding the processing capacity of a node that performs scheduling. This poses a problem in that scheduling cannot be finished within a set scheduling time.

### SUMMARY

According to an aspect of an embodiment, a scheduling method is executed by a first device, and includes acquiring in response to a process request received by the first device, any one among a device count of peripheral devices near the first device and a device count of the peripheral devices near the first device, including the first device; and determining, by a CPU of the first device, a scheduling method for scheduling a process corresponding to the process request, based on the device count.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of an embodiment;

FIG. 2 is a block diagram of an example of a hardware configuration of a terminal;

FIG. 3 is a block diagram of a functional example of an OS 221;

FIG. 4 is an explanatory diagram of an example of acquisition of the number of terminals;

FIGS. 5A and 5B are explanatory diagrams of an example of terminal parameters;

FIG. 6 is an explanatory diagram of an example of priority levels;

FIG. 7 is an explanatory diagram of an example of dividing rendering process data 600;

FIG. 8 is an explanatory diagram of an example of a threshold;

FIG. 9 is an explanatory diagram (1) of an example of assignment;

FIG. 10 is an explanatory diagram (2) of an example of assignment;

FIG. 11 is an explanatory diagram of an example of combining process results together; and

FIGS. 12 and 13 are flowcharts of an example of a scheduling procedure executed by the OS 221.

### DESCRIPTION OF EMBODIMENTS

An embodiment of a scheduling method and a scheduling system will be described in detail with reference to the accompanying drawings. In the present embodiment, a mobile terminal will be described as an example of the scheduling system.

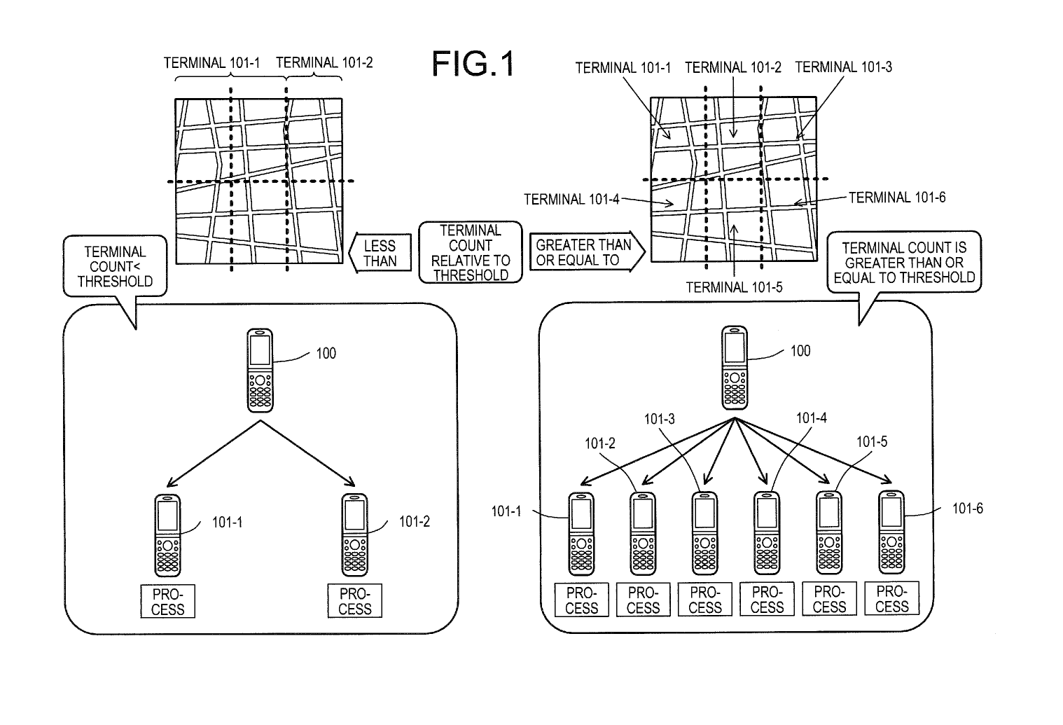

FIG. 1 is an explanatory diagram of an example of the present embodiment. For example, a terminal 100 acquires the number of peripheral terminals near the terminal 100 or the number of peripheral terminals near the terminal 100, including the terminal 100, as a terminal count, in response to a process request received by the terminal 100. In FIG. 1, for example, the process request received by the terminal 100 is a map rendering process. For example, the peripheral terminals near the terminal 100 are terminals that communicate by a handshake procedure with a base station connected to the terminal 100 or terminals belonging to an ad hoc network to which the terminal 100 belongs.

For example, the terminal 100 determines a scheduling method for scheduling a process according to the acquired number of terminals. If the number of terminals is smaller than a threshold, for example, the terminal 100 schedules the process by a first scheduling method. If the number of terminals is greater than or equal to the threshold, the terminal 100 schedules the process by a second scheduling method.

According to the first scheduling method indicated in FIG. 1, the assignment of processes to the peripheral terminals near the terminal 100 is determined based on load information, the remaining battery power of the peripheral terminals and on the speed of communication between the terminal 100 and the peripheral terminals. For example, a terminal 101-1 is running no application but a terminal 101-2 is running several applications. Thus, the terminal 100 assigns ⅔ of the rendering process to the terminal 101-1 and ⅓ of the rendering process to the terminal 101-2.

For example, according to the second scheduling method indicated in FIG. 1, an assignment destination terminal to which a process is assigned is determined regardless of the capacities of the peripheral terminals. For example, the terminal 100 divides the rendering process into 6 sub-processes and assigns the sub-processes each equivalent to ⅙ of the rendering process to the terminals 101-1 to 101-6, respectively.

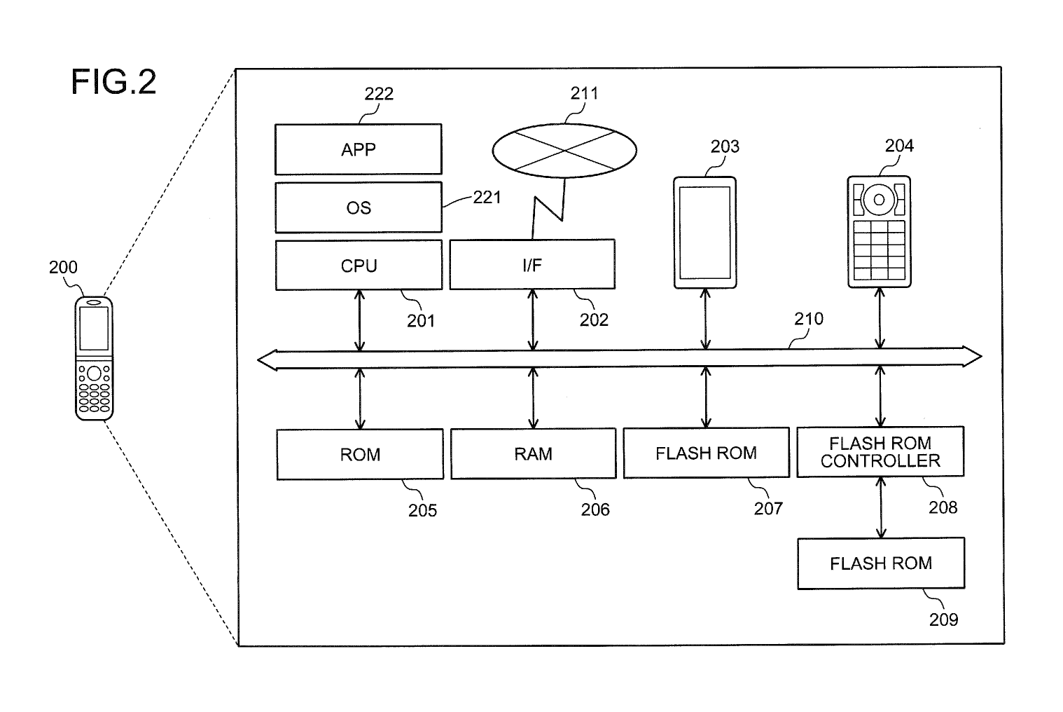

FIG. 2 is a block diagram of an example of a hardware configuration of a terminal. In FIG. 2, a terminal 200 includes a CPU 201, a display 203, a keyboard 204, an interface (I/F) 202, random access memory (RAM) 206, and read-only memory (ROM) 205. The terminal 200 also includes flash ROM 207, a flash ROM controller 208, and flash ROM 209. The CPU 201, the display 203, the keyboard 204, the interface (I/F) 202, the RAM 206, and the ROM 205, the flash ROM 207, and the flash ROM controller 208 are interconnected through a bus 210.

The CPU 201 has a register, a core, and a cache. The core has a computing function. The CPU 201 supervises overall control of the terminal 200 and executes an OS 221. The OS 221 has a function of controlling the order of execution of applications assigned to the CPU 201 and a function of assigning distributed processes to peripheral terminals when receiving a distributed processing request.

In FIG. 2, an app 222 is assigned to the OS 221. The app 222 is, for example, map search software. When a rendering process is to executed, the app 222 sends a distributed processing request to the OS 221.

The display 203 displays, for example, data such as text, images, functional information, etc., in addition to a cursor, icons, and/or tool boxes. A thin-film-transistor (TFT) liquid crystal display and the like may be employed as the display 203. The keyboard 204 includes, for example, keys for inputting letters, numerals, and various instructions and performs the input of data. Alternatively, a touch-panel-type input pad or numeric keypad, etc. may be adopted.

The I/F 202 is connected to a network 111 such as a local area network (LAN), a wide area network (WAN), and the Internet through a communication line and is connected to other apparatuses through the network 111. The I/F 202 administers an internal interface with the network 111 and controls the input and output of data with respect to external apparatuses. For example, a modem or a LAN adaptor may be employed as the I/F 202.

The ROM 205 stores therein programs such as a boot program. The RAM 206 is used as a work area of the CPU 201. The flash ROM 207 stores system software such as the OS 221, and application software. The access speed of the RAM 206 by the CPU 201 is faster than that of flash ROM 207.

The flash ROM controller 208, under the control of the CPU 201, controls the reading and writing of data with respect to the flash ROM 209. The flash ROM 209 stores therein data written under control of the flash ROM controller 208. Examples of the data include image data and video data acquired by the user of the multi-core processor system through the I/F 202. A memory card, SD card and the like may be adopted as the flash ROM 209.

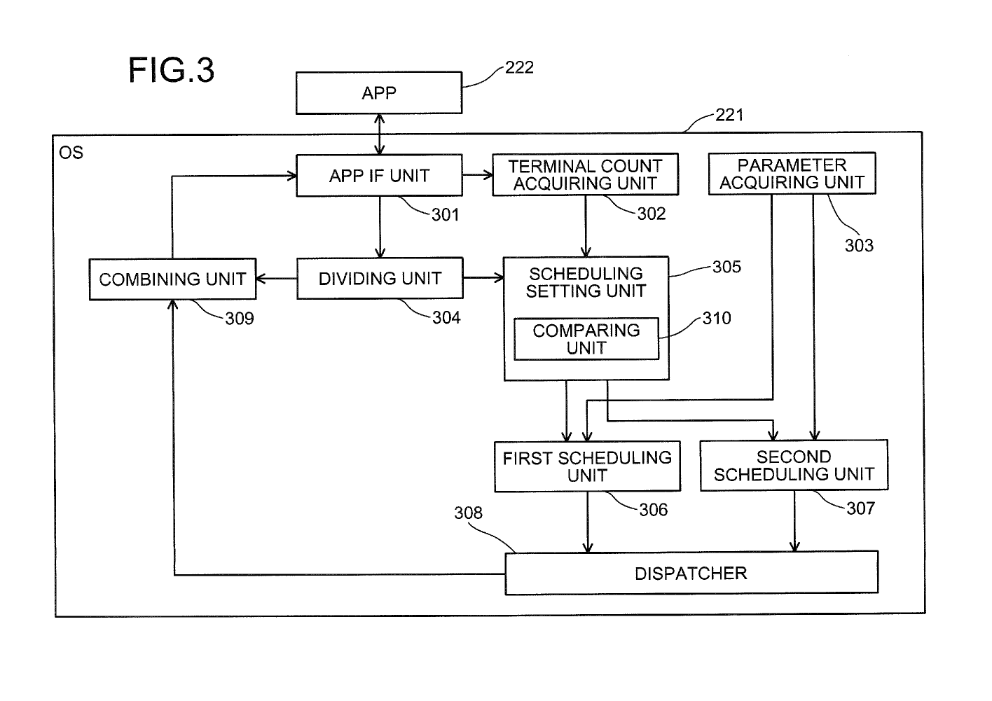

FIG. 3 is a block diagram of a functional example of the OS 221. The OS 221 includes an app IF unit 301, a terminal count acquiring unit 302, a parameter acquiring unit 303, a dividing unit 304, and a scheduling setting unit 305. The OS 221 also includes a first scheduling unit 306, a second scheduling unit 307, a dispatcher 308, and a combining unit 309.

For example, processes of the app IF unit 301 to combining unit 309 are coded in the OS 221. The CPU 201 reads the OS 221 from a memory device, such as the ROM 205 and flash ROM 207, and executes a process coded in the OS 221, whereby the processes of the app IF unit 301 to combining unit 309 are implemented.

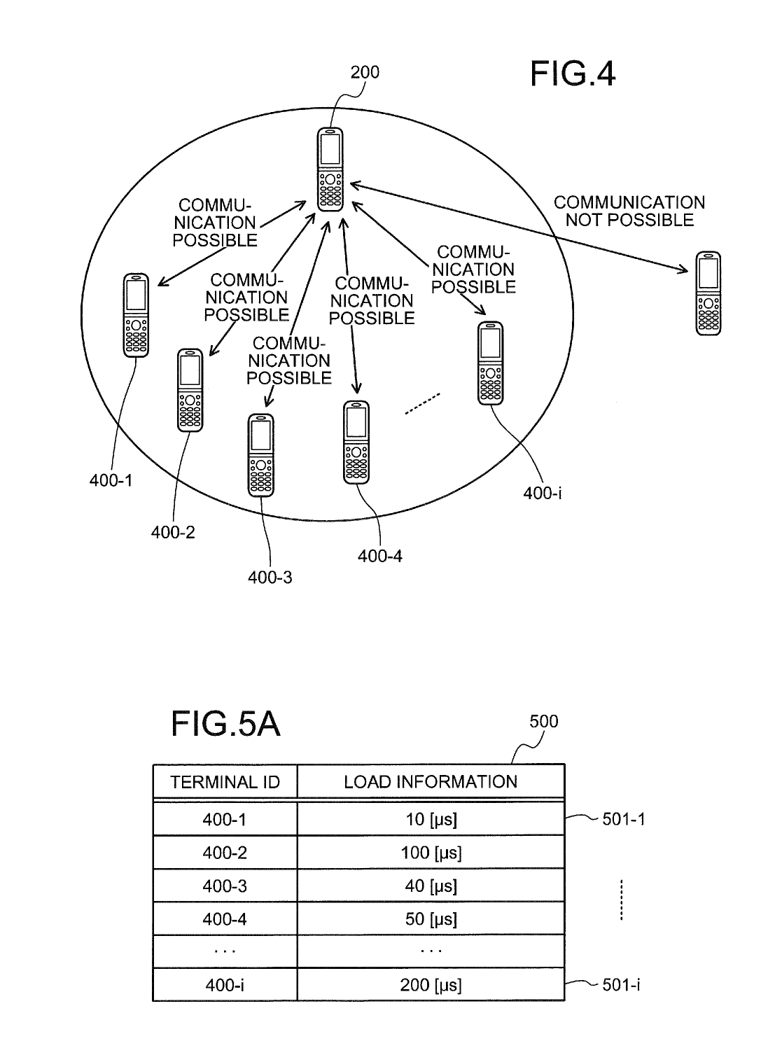

FIG. 4 is an explanatory diagram of an example of acquisition of the number of terminals. For example, the OS 221 receives a request from the app 222 for distributed processing of a map rendering process, via the app IF unit 301. The OS 221 acquires the number of peripheral terminals near the terminal 200, via the terminal count acquiring unit 302 and sends, via an ad hoc network 221, an inquiry to other terminals to inquire whether communication with the terminal 200 is possible. For example, the OS 221 determines the number of terminals having responded to the inquiry to be the number of peripheral terminals near the terminal 200. In this example, terminals 400-1 to 400-i are the peripheral terminals near the terminal 200. The number of the peripheral terminals near the terminal 200 is, therefore, i.

As described, the OS 221 may access a base station connected to the terminal 200 and acquire the number of terminals that communicate by a handshake procedure with the base station, and thus, determine the acquired number of terminals to be the number of the peripheral terminals near the terminal 200.

The OS 221, via the parameter acquiring unit 303, sends a request to the terminals 400-1 to 400-i capable of communicating with the terminal 100, requesting transmission of respective parameters of the terminals 400-1 to 400-i. Receiving the request for transmission of the parameters, each of the terminals 400-1 to 400-i transmits parameters thereof to the terminal 200. For example, the OS 221 receives terminal parameters from each of the terminals 400-1 to 400-i, via the parameter acquiring unit 303. Terminal parameters include, for example, remaining battery power, load information, and communication speed.

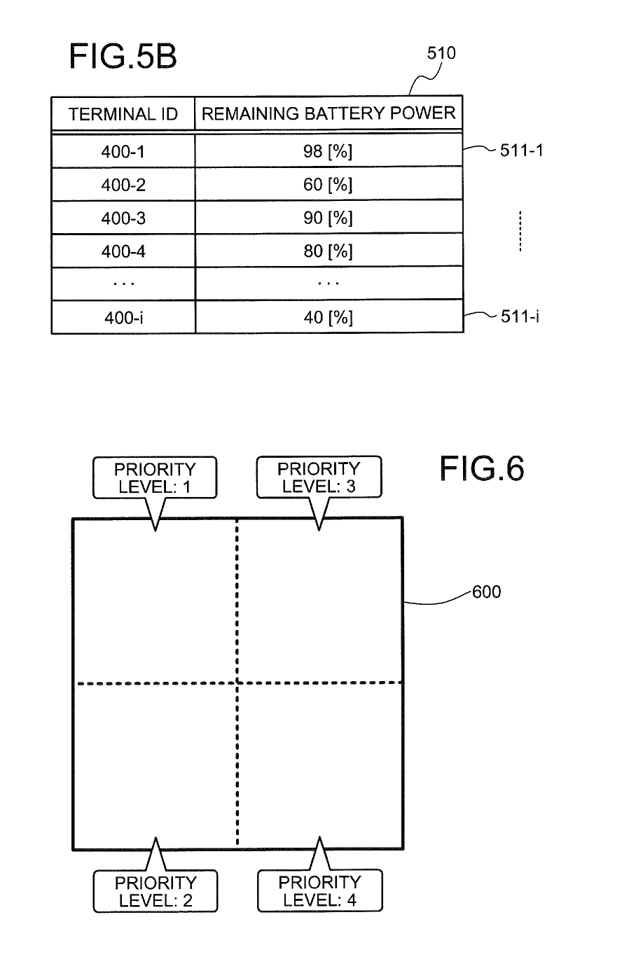

FIGS. 5A and 5B are explanatory diagrams of an example of terminal parameters. In FIG. 5A, a table 500 indicates load information of each terminal. The table 500 has fields of “terminal ID” and “load information”. “Terminal ID” is identification information that identifies a peripheral terminal near the terminal. “Load information” represents the total processing time of a process under execution by each terminal. Information is entered into each field and stored as terminal load records 501-1 to 501-i.

In FIG. 5B, a table 510 indicates the remaining battery power of each terminal. The table 510 has fields of “terminal ID” and “remaining battery power”. “Terminal ID” is identification information that identifies a peripheral terminal near the terminal 200. “Remaining battery power” is a value indicating in terms of percentage the remaining power level of the battery of each terminal. Information is entered into each field and stored as terminal load records 511-1 to 511-i.

In this embodiment, an example of scheduling using load information of each peripheral terminal is described. Scheduling, however, may be performed by using the remaining battery power of the peripheral terminal, or by using the speed of communication between the terminal 200 and peripheral terminals near the terminal 200 (not depicted), or according to a determination that is made based on a combination of the load information, remaining battery power, and communication speed with the peripheral terminals.

For example, via the app IF unit 301, the OS 221 acquires priority level information concerning a rendering process, rendering process data, and the number of divisions or a division size, from the app 222. Rendering process data 600 includes, for example, program codes, variables, and variable values related to the rendering process.

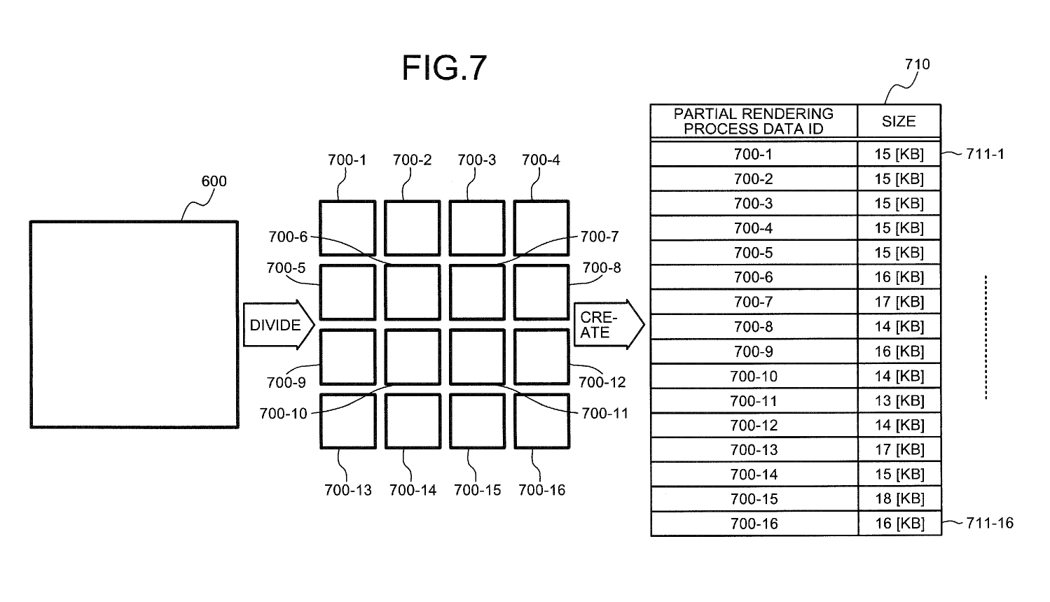

FIG. 6 is an explanatory diagram of an example of priority levels. In FIG. 6, the acquired rendering process data 600 is divided into four partial rendering process data. In FIG. 6, for ease of understanding, the rendering process data 600 is depicted in the form of a rendering area. In the rendering process data 600, the partial rendering process data on the upper left is given the highest priority, the partial rendering process data on the lower left is given the second highest priority, the partial rendering process data on the upper right is given the third highest priority, and the partial rendering process data on the lower right is given the lowest priority.

Priority level information is information indicative of which partial process among the rendering process is given high priority. For example, in the priority level information, a priority level is associated with the address or step number of the rendering process data 600.

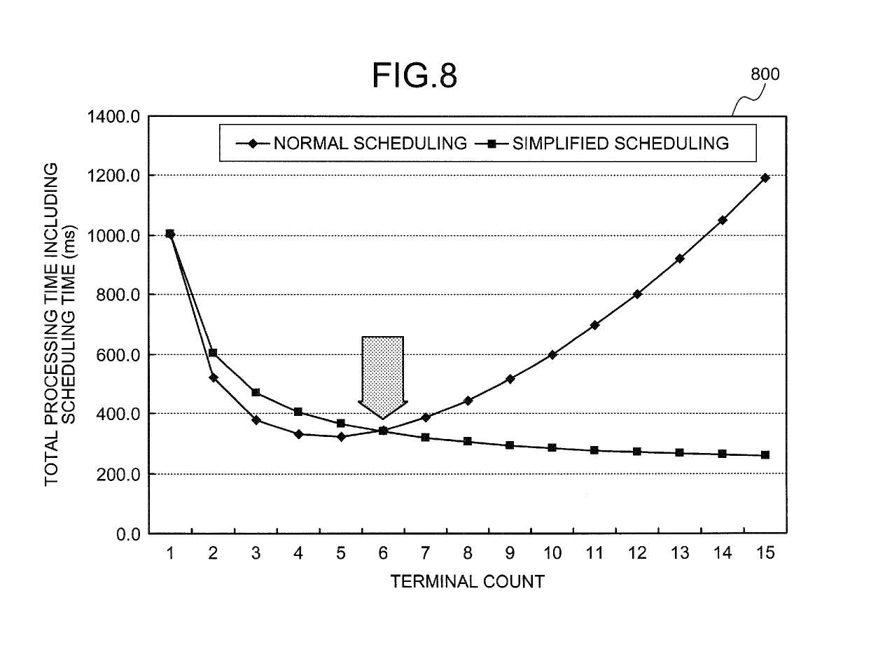

FIG. 7 is an explanatory diagram of an example of dividing the rendering process data 600. For example, the OS 221 divides the acquired rendering process data 600 according to a divisor. In FIG. 7, the rendering process data 600 is divided into partial rendering process data 700-1 to 700-16. The result of the division is stored in the memory device, such as the RAM 206 and flash ROM 207.

For example, the OS 221 creates division data for each of the partial rendering process data 700-1 to 700-16. In FIG. 7, a division data group 710 has fields of “partial rendering process data ID” and “size”. “Partial rendering process data ID” is identification information indicates data of a partial rendering process. In this example, each partial rendering process data ID is the same as the reference numeral given to each partial rendering process data. “Size” is the size of partial rendering process data. Information is entered into each field and stored as division data record 711-1 to 711-16. For example, the division data group 710 is stored in the memory device, such as the RAM 206 and flash ROM 207.

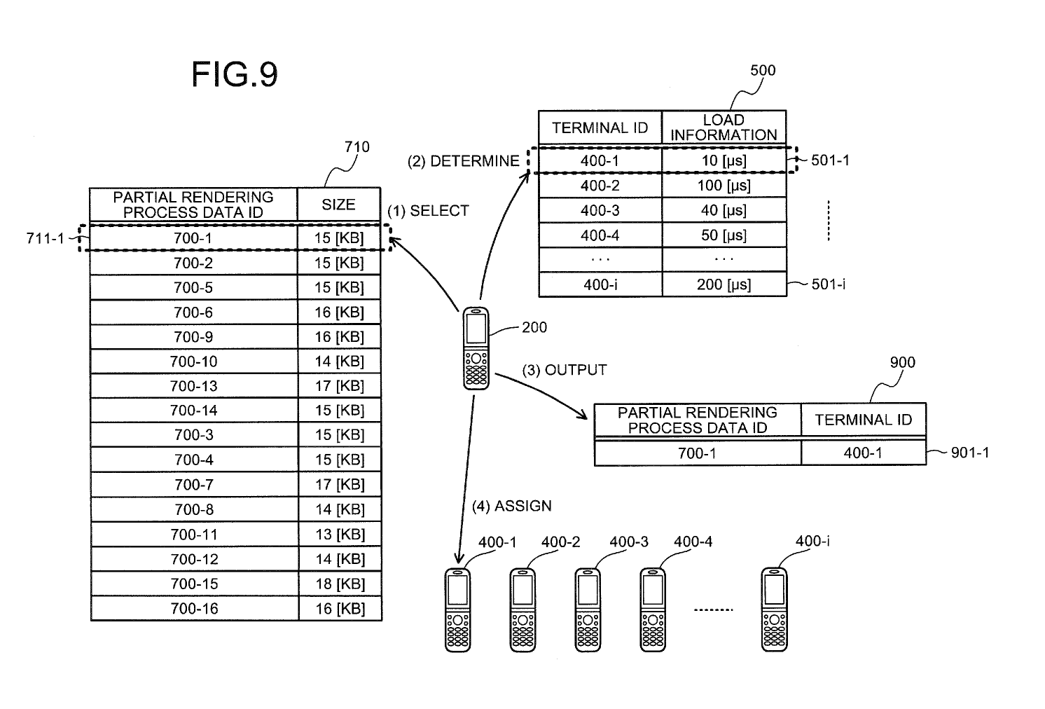

The OS 221 then determines whether the number of peripheral terminals near the terminal 200 is smaller than a threshold, via the comparing unit 310 of the scheduling setting unit 305, or determines whether the number of peripheral terminals near the terminal 200, including the terminal 200, is smaller than the threshold, via the comparing unit 310 of the scheduling setting unit 305. The threshold will be described in detail referring to FIG. 8.

FIG. 8 is an explanatory diagram of an example of the threshold. A graph 800 indicates the relation between the processing time and the number of terminals in a case of performing normal scheduling and the relation between the processing time and the number of terminals in a case of performing simplified scheduling. The processing time means the total processing time including the scheduling time.

The normal scheduling means scheduling of determining an assignment destination terminal, to which a partial rendering process by the application is assigned, based on load information and remaining battery power of peripheral terminals. The simplified scheduling means scheduling of sequentially determining an assignment destination terminal, to which a partial rendering process by the application is assigned, regardless of load information and remaining battery power of peripheral terminals.

As describe, according to the scheduling algorithm, the processing time, ideally, decreases in inverse proportion to the number of nodes but the scheduling time increases exponentially. For this reason, the total processing time becomes, for example, similar to a normal scheduling curve indicated in FIG. 8. In the case of the simplified scheduling, the scheduling time is substantially constant regardless of the number of computing nodes but assignment of processes is not optimally performed and involves a risk of assigning a process to an unsuitable terminal. As a result, the processing time is expressed as an expected value including risks and costs.

It is observed in the graph 800 that the normal scheduling curve and the simplified scheduling curve intersect. The intersection (indicated by an arrow) of the curves is used as the threshold, and when the number of peripheral terminals near the terminal 200 exceeds the threshold, the simplified scheduling is adopted. For example, because the number of terminals corresponding to the intersection is 6, the threshold is determined to be 6. An example of making the graph 800 will be described. First, a total processing time t is calculated by equation (1).

t=ts+tp (1)

In equation (1), a time ts represents the time consumed for scheduling, and a time tp represents the time consumed for executing each sub-process. The time ts consumed in the case of the normal scheduling is calculated by equation (2).

ts=tc×N̂2 (2)

In equation (2), N denotes the number of terminals, N̂2 denotes the square of N, and a time tc represents the time consumed for each round of scheduling calculation. The time tp consumed in the case of the normal scheduling is calculated by equation (3).

tp=T/N (3)

In equation (3), a time T represents the time consumed for executing the entire process. The time is consumed in the case of the simplified scheduling is calculated by equation (4) and the time tp consumed in the same case is calculated by equation (5).

ts=tc′ (4)

tp=T/N+T/N×P×(N−1)=T/N{1+P×(N−1)} (5)

In equations (4) and (5), a time tc′ represents the time consumed for simplified scheduling calculation and risk P represents risk that arises when the optimum scheduling is not performed. The result of calculation using the equations (1) to (4) under conditions of tc=tc′=5 [ms], T=1000 [ms], and P=20[%] is indicated in the graph 800.

Processing by the OS 221 is described. For example, when the OS 221 determines that the acquired number of terminals is less than the threshold, via the scheduling setting unit 305, the OS 221 adopts the first scheduling method. According to the first scheduling method, for example, the OS 221 performs the normal scheduling, via the first scheduling unit 306. In other words, according to the first scheduling method, process assignment to the peripheral terminals near the terminal 200 is determined based on load information and remaining battery power of the peripheral terminals.

For example, if the OS 221 determines that the acquired number of terminals is not less than the threshold, via the scheduling setting unit 305, and the number of partial rendering processes already assigned to terminals is less than the threshold, the OS 221 adopts the first scheduling method. For example, if the OS 221 determines that the acquired number of terminals is not less than the threshold, via the scheduling setting unit 305, and the number of partial rendering processes already assigned to terminals is greater than or equal to the threshold, the OS 221 adopts the second scheduling method to assign the partial rendering processes exceeding the threshold. For example, according to the second scheduling method, the OS 221 performs the simplified scheduling, via the second scheduling unit 307.

For example, a case is assumed where i≧6 is set and the OS 221 determines that the acquired number of terminals is not less than the threshold, via the scheduling setting unit 305, and thus, adopts the second scheduling method. In this case, for example, the OS 221 rearranges the division data of the division data group 710 in descending order of priority, based on priority level information. The rearranged division data group 710 is stored to a memory device, such as the RAM 206 and flash ROM 207.

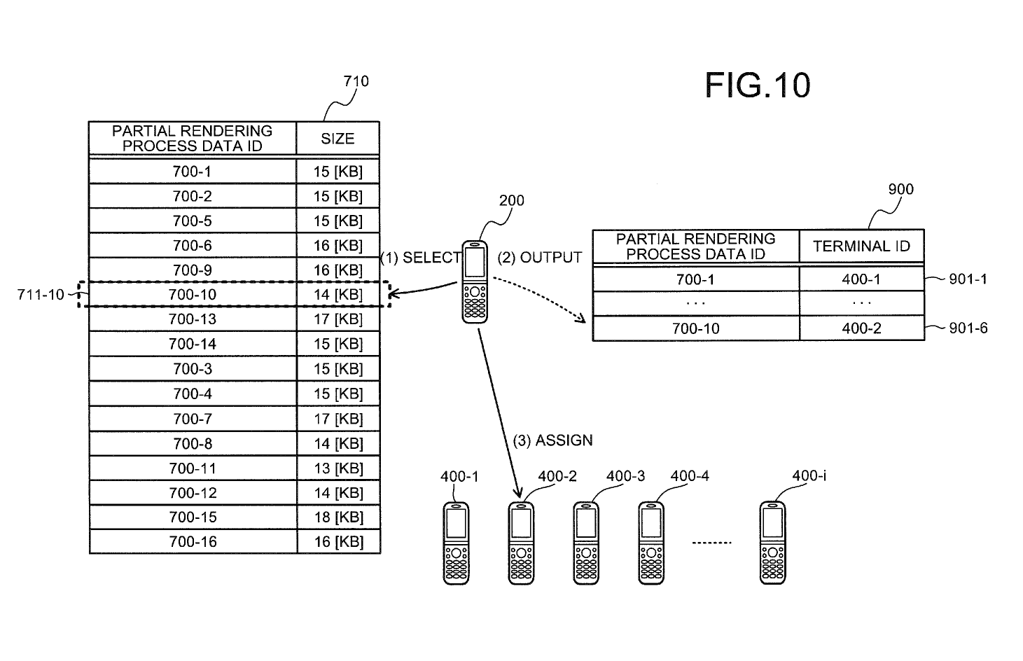

FIG. 9 is an explanatory diagram (1) of an example of assignment. For example, the OS 221 (1) sequentially selects division data, from the rearranged division data group 710. In this example, division data record 711-1 is selected. The OS 221 refers to a table 500, via the second scheduling unit 307, and identifies a terminal having the lightest load. Because the terminal 400-1 has the lightest load information value in FIG. 9, the terminal 400-1 is identified as the terminal having the lightest load. The OS 221 (2) determines, via the second scheduling unit 307, the identified terminal 400-1 to be an assignment destination terminal to which the process indicated in the division data record 711-1 is to be assigned.

For example, the OS 221 (3) outputs the result of the determination to assignment information 900, via the second scheduling unit 307. The assignment information 900 has fields of “partial rendering process data ID” and “terminal ID”. In the “partial rendering process data ID” field, the partial rendering process data ID indicated in the selected division data record 711-1 is entered. In the “terminal ID” field, the terminal ID of the determined assignment destination terminal is entered. The “partial rendering process data ID” field of the assignment information 900 is associated with the “partial rendering process data ID” field of the division data group 710. Information is entered into each field and stored as assignment result record 901-1. For example, the OS 221 (4) assigns, via the dispatcher 308, the process indicated in the division data record 711-1 to the terminal 400-1, which has been determined to be the assignment destination terminal.

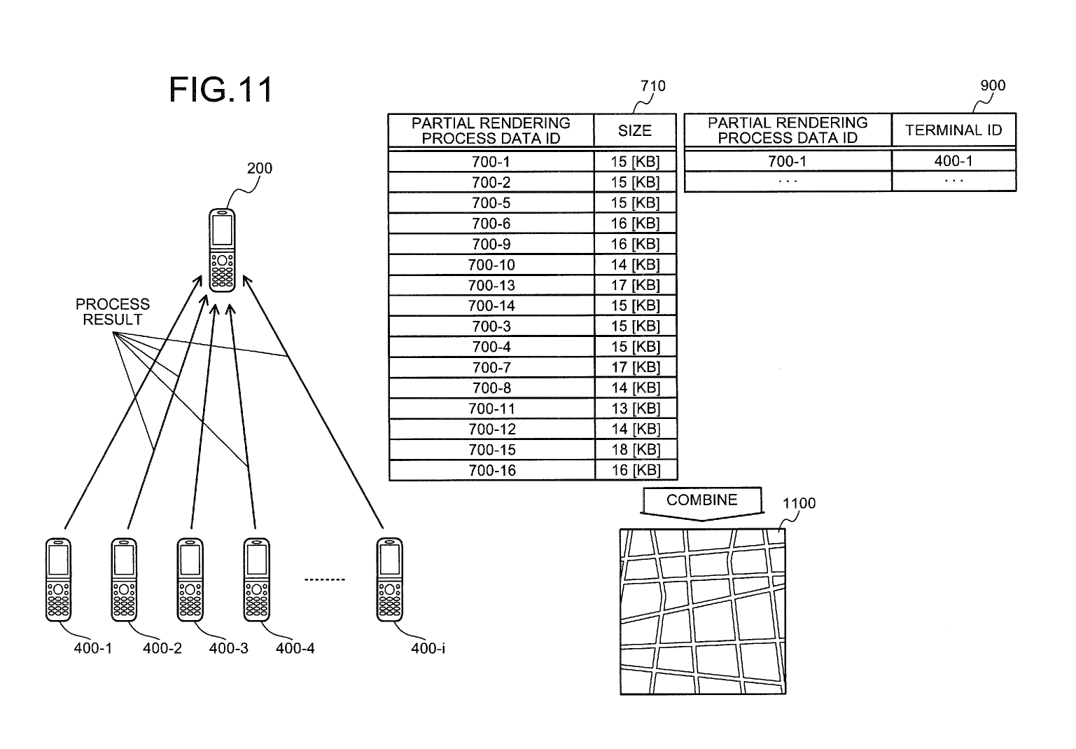

FIG. 10 is an explanatory diagram (2) of an example of assignment. For example, the OS 221 (1) selects division data from the division data group 710. In this example, the threshold is 6 and therefore, the 6-th division data record 711-10 is selected from the division data group 710. Hence, the OS 221 performs the simplified scheduling via the second scheduling unit 307. For example, because no process has been assigned to the terminal 400-2 yet, the OS 221 determines, via the second scheduling unit 307, the terminal 400-2 to be an assignment destination terminal to which a process indicated in the division data record 711-10 is to be assigned. For example, the OS 221 (2) outputs the result of the determination to the assignment information 900, via the second scheduling unit 307. As a result, a record of assignment result record 901-6 is added to the assignment information 900. For example, the OS 221 (4) assigns the process indicated in the division data record 711-10 to the assignment destination terminal, via the dispatcher 308.

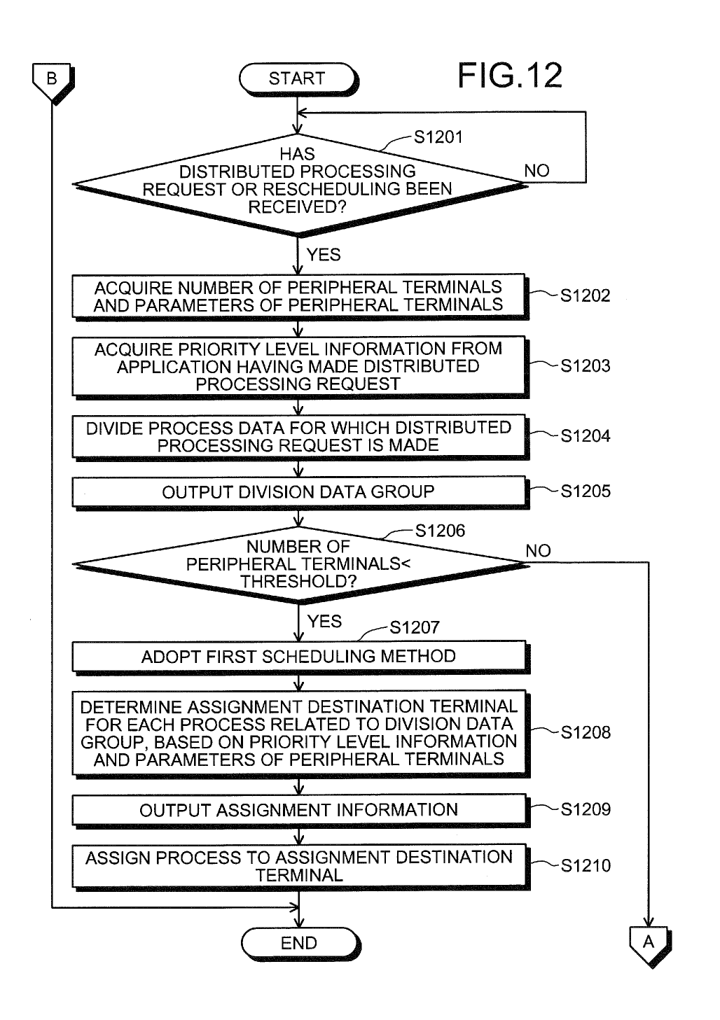

FIG. 11 is an explanatory diagram of an example of combining process results together. For example, the OS 221 receives a process result from each terminal via the dispatcher 308. For example, the OS 221 determines, via the combining unit 309, the location that each received rendering process represents, based on the assignment information 900 and the division data group 710. For example, the OS 221 combines all process results based on the result of the determination, via the combining unit 309. The OS 221 sends a combination result 1100 to the app 222, via the app IF unit 301.

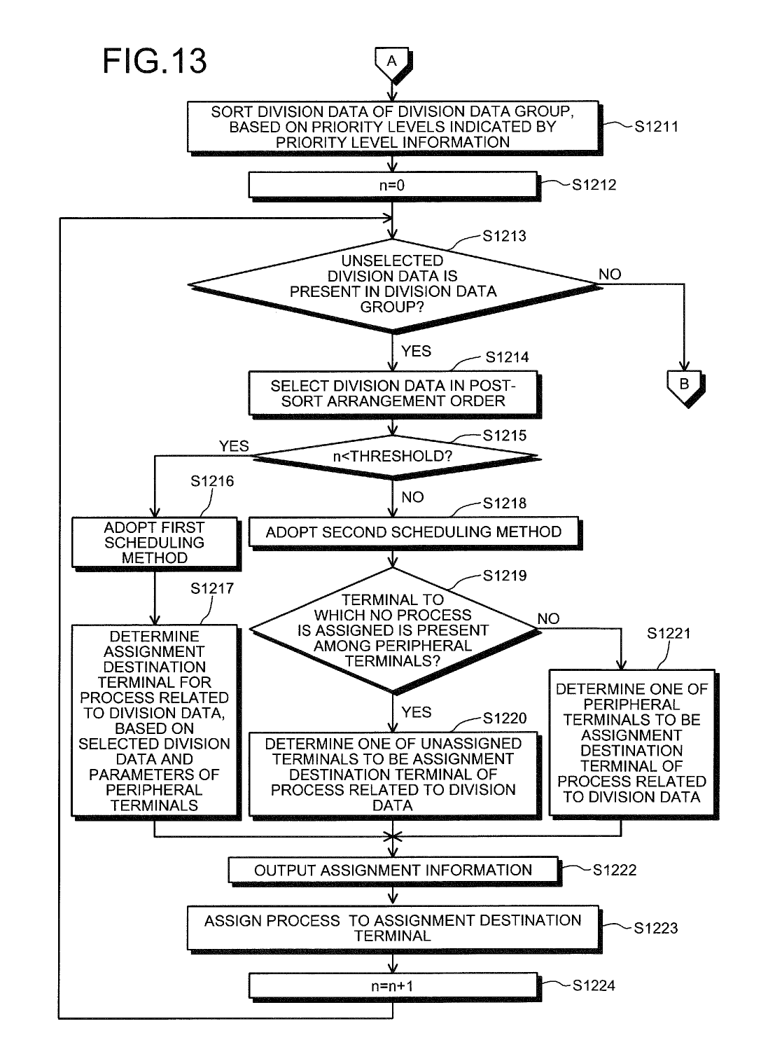

FIGS. 12 and 13 are flowcharts of an example of a scheduling procedure executed by the OS 221. The OS 221 determines whether a distributed processing request or rescheduling has been received (step S1201). If no distributed processing request or rescheduling has been received (step S1201: NO), the OS returns to step S1201. If a distributed processing request or rescheduling has been received (step S1201: YES), the OS acquires the number of peripheral terminals and the parameters of the peripheral terminals, via the terminal count acquiring unit 302 and the parameter acquiring unit 303 (step S1202).

The OS 221 acquires, via the app IF unit 301, priority level information from an application having made the distributed processing request (step S1203). The OS 221 divides, via the dividing unit 304, process data for which the distributed processing request is made (step S1204), and outputs the division data group 710 (step S1205). The OS 221 determines whether number of peripheral terminals<threshold is true (step S1206).

If number of peripheral terminals<threshold is true (step S1206: YES), the OS 221 adopts the first scheduling method, via the scheduling setting unit 305 (step S1207). Via the first scheduling unit 306, the OS 221 determines assignment destination terminals for the division data of the division data group 710, based on the priority level information and the parameters of the peripheral terminals (step S1208). The OS 221 adds the result of the determination to the assignment information 900 and outputs the assignment information 900 (step S1209). The OS 221 assigns the process related to the division data of the division data group 710 to the assignment destination terminal, via the dispatcher 308 (step S1210), and ends the series of operations.

If number of peripheral terminals<threshold is not true (step S1206: NO), the OS 221 sorts the division data of the division data group 710, based on priority levels indicated by the priority level information (step S1211).

The OS 221 sets n=0 (step S1212) and determines whether unselected division data is present in the division data group 710 (step S1213). If unselected division data is present in the division data group 710 (step S1213: YES), the OS 221 selects division data in the post-sort arrangement order (step S1214). Via the scheduling setting unit 305, the OS 221 determines whether n<threshold is true (step S1215).

If n<threshold is true (step S1215: YES), the OS 221 adopts the first scheduling method, via the scheduling setting unit 305 (step S1216). Based on the selected division data and the parameters of each peripheral terminal, the OS 221 determines an assignment destination terminal to which the process related to the division data is to be assigned (step S1217), and proceeds to step S1222. If n<threshold is not true (step S1215: NO), the OS 221 adopts the second scheduling method, via the scheduling setting unit 305 (step S1218), and determines, via the second scheduling unit 307, whether a terminal to which no process is assigned is present among the peripheral terminals (step S1219).

If a terminal to which no process is assigned is present among the peripheral terminals (step S1219: YES), the OS 221 determines, via the second scheduling unit 307, one of terminals to be an assignment destination terminal to which the process related to the division data is to be assigned (step S1220). Following step S1220, the OS 221 proceeds to step S1222. If a terminal to which no process is assigned is not present among the peripheral terminals (step S1219: NO), the OS 221 determines, via the second scheduling unit 307, one of the peripheral terminals to be an assignment destination terminal to which the process related to the division data is to be assigned (step S1221), and proceeds to step S1222.

Following steps S1217, S1220, and S1221, the OS 221 adds the result of determination of the assignment destination terminal to the assignment information 900, and outputs the assignment information 900 (step S1222). The OS 221 assigns the process related to the division data to the assignment destination terminal, via the dispatcher 308 (step S1223), sets n=n+1 (step S1224), and proceeds to step S1213.

If unselected division data is not present in the division data group 710 (step S1213: NO), the OS 221 ends the series of operations.

As described, according to the scheduling method and the scheduling system, when a process is distributed among peripheral devices, the scheduling method that is preferable is determined according to the number of peripheral devices. As a result, the scheduling time can be reduced.

If the number of devices is less than the threshold, the process is scheduled by the first scheduling method. If the number of devices is greater than or equal to the threshold, the process is scheduled by the second scheduling method. In this manner, the scheduling method is selected easily to reduce the scheduling time.

If the number of devices is greater than or equal to the threshold, a process for first data that corresponds to data blocks of a number less than or equal to the threshold is scheduled by the first scheduling method. If second data other than the first data is present, a process for the second data is scheduled by the second scheduling method. In this manner, optimal scheduling is performed within a range such that the scheduling time does not affect the processing time. Thus, optimal scheduling is performed and the scheduling time is reduced.

Data to be processed is divided into multiple data blocks. Following the completion of processing of divided data blocks, the data blocks are combined together. In this manner, a process to be executed by a given terminal can be distributed among multiple terminals for execution of the distributed portions of the process.

According to the first scheduling method, process scheduling is performed based on division data, priority level information, and parameters. According to the second scheduling method, process scheduling is performed based on division data and priority level information. As a result, the optimal scheduling is performed and the scheduling time is reduced.

Parameters represent the remaining battery power or communication speeds of a first device and peripheral devices near the first device. Using the parameters, a process can be distributed according to the state of the peripheral devices.

The number of peripheral devices represents the number of devices with which the base station connected to the first device can communicate or the number of devices included in an ad hoc network to which the first device belongs. Thus, number of peripheral terminals can be acquired easily.

The scheduling method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A scheduling method executed by a first device, the scheduling method comprising:
acquiring in response to a process request received by the first device, any one among a device count of peripheral devices near the first device and a device count of the peripheral devices near the first device, including the first device; and
determining, by a CPU of the first device, a scheduling method for scheduling a process corresponding to the process request, based on the device count.

2. The scheduling method according to claim 1, wherein
the determining includes determining the scheduling method to be a first scheduling method, when the device count is less than a threshold, and determining the scheduling method to be a second scheduling method, when the device count is at least the threshold.

3. The scheduling method according to claim 1, wherein
the determining includes determining the scheduling method to be a first scheduling method by which the process for first data that corresponds to data blocks of a number that is at most a threshold is scheduled, when the device count is at least the threshold, and when second data other than the first data is present, determining the scheduling method to be a second scheduling method by which the process for the second data is scheduled.

4. The scheduling method according to claim 3, comprising:
dividing into the data blocks, data to be subjected to the process; and
combining the data blocks following completion of the process.

5. The scheduling method according to claim 2, wherein
according to the first scheduling method, scheduling of the process is performed based on division data, priority level information, and parameters, and
according to the second scheduling method, scheduling of the process is performed based on the division data and the priority level information.

6. The scheduling method according to claim 5, wherein
the parameters include at least any one among remaining battery power and communication speeds of the first device and the peripheral devices near the first device.

7. The scheduling method according to claim 1, wherein
a count of peripheral devices near the first device represents any one among a count of devices with which a base station connected to the first device can communicate and a count of devices included in an ad hoc network to which the first device belongs.

8. A scheduling system comprising:
a processor configured to:
receive a process,
acquire in response to receiving the process, any one among a device count of peripheral devices near a first device and a device count of the peripheral devices near the first device, including the first device, and
set a scheduling method for scheduling the process, based on the number of devices.

9. The scheduling system according to claim 8, wherein
the processor is configured to compare the device count and a threshold.

10. The scheduling system according to claim 8, wherein
the processor is configured to schedule the process by a first scheduling method, and by a second scheduling method different from the first scheduling method.

11. The scheduling system according to claim 10, wherein
the processor is configured to divide into a given number of data blocks, data to be subjected to the process,
the processor schedules, by the first scheduling method, the process for data blocks that are among the given number of data blocks and of a number that is at most the device count, and
the processor schedules, by the second scheduling method, the process for each data block, excluding the data blocks of the number that is at most the device count.

12. The scheduling system according to claim 10, wherein
the processor schedules the process by the first scheduling method and based on division data, priority level information, and parameters, and
the processor schedules the process by the second scheduling method and based on the division data and the priority level information.

13. The scheduling system according to claim 12, wherein
the parameters include at least any one among remaining battery power and communication speeds of the first device and the peripheral devices near the first device.
